(19) United States
(12) Patent Application Publication
(10) Pub. No.: US 2015/0139467 A1
(43) Pub. Date: May 21, 2015

(54) ACOUSTIC DEVICE AND MICROPHONE PACKAGE INCLUDING THE SAME

(71) Applicant: SAMSUNG ELECTRO-MECHANICS CO., LTD., Suwon-Si (KR)

(72) Inventor: Heung Woo PARK, Suwon-Si (KR)

(73) Assignee: SAMSUNG ELECTRO-MECHANICS CO., LTD., Suwon-Si (KR)

(21) Appl. No.: 14/268,597

(22) Filed: May 2, 2014

(30) Foreign Application Priority Data
Nov. 21, 2013 (KR) 10-2013-0141988

(51) Int. Cl. H04R 1/04

(52) U.S. Cl. CPC H04R 1/04
USPC 381/355

(57) ABSTRACT

There are provided an acoustic device manufactured using a micro electro mechanical system (MEMS) technology, and a microphone package including the acoustic device. The acoustic device includes a device substrate including a cavity formed therein, a diaphragm formed to cover the cavity on the device substrate, a back plate formed to be spaced apart from the diaphragm, and a shielding plate disposed to be spaced apart from the diaphragm and the back plate, including a plurality of through holes, and shielding noise introduced from outside.

### CROSS-REFERENCE TO RELATED APPLICATION

This application claims the benefit of Korean Patent Application No. 10-2013-0141988 filed on Nov. 21, 2013, with the Korean Intellectual Property Office, the disclosure of which is incorporated herein by reference.

### BACKGROUND

The present disclosure relates to an acoustic device and a microphone package including the same, and more particularly, to an acoustic device manufactured by a micro electromechanical system (MEMS) technology, and a microphone package including the same.

Recently, with the development of miniaturized electronic products, components installed thereon have been miniaturized, and accordingly, a MEMS acoustic transducer has been preferentially used as an acoustic signal input device that has been widely used in mobile communications terminals, audio systems, or the like.

MEMS acoustic transducers may be classified as piezoresistive type acoustic transducers, piezoelectric type acoustic transducers, and condenser type acoustic transducers.

Piezoresistive type MEMS acoustic transducers use a principle whereby a resistance value varies according to vibrations, and thus, may be disadvantageous in that a constant audio range frequency may not be maintained due to the resistance value varying according to environmental changes (temperature, humidity, suspended dust, and the like).

Piezoelectric type MEMS acoustic transducers use a piezoelectric effect for generating a difference in potentials between opposite ends of a vibration plate, and thus, although an electrical signal varies according to the acoustic pressure through a voice signal, the commercialization of piezoelectric type MEMS acoustic transducers is somewhat restricted due to a low band and non-uniform voice band frequency characteristics thereof.

On the other hand, a condenser type MEMS acoustic transducer is configured in such a manner that one of two metallic plates is used as a fixed electrode, the other metallic plate is used as a vibration plate that vibrates in response to an acoustic signal, and an air gap of several μm to several tens of μm is formed between two electrodes and measures a level of electrostatic capacitance that varies between the vibration plate and the fixed electrode when the vibration plate vibrates according to a sound source. Thus, the condenser type MEMS acoustic transducer is advantageous in terms of stability of conversion sound range and frequency characteristics.

Thus, condenser type MEMS acoustic transducers have mainly been used as MEMS acoustic transducers.

Such condenser type MEMS acoustic transducers have been manufactured and used in the form of microphone packages. For example, as a main structure, an acoustic transducer, a semiconductor device and the like may be installed on a substrate, and a shield cover for shielding surrounding noise may be disposed thereon. Here, the acoustic transducer and the semiconductor device are disposed to be accommodated in the shield cover.

However, such MEMS acoustic transducers according to the related art may include a shield cover for shielding electromagnetic waves as described above, and thus, a process for coupling a plate to a substrate is needed. Accordingly, a MEMS acoustic transducer according to the related art is somewhat disadvantageous in terms of having a complex manufacturing process and a relatively large volume.

### RELATED ART DOCUMENT

Korean Utility Model Laid-Open Publication No. 2008-0005779

### SUMMARY

Some embodiments of the present disclosure may provide an acoustic transducer and a microphone package including the same, from which an existing shield cover is omitted.

According to some embodiments of the present disclosure, an acoustic device may include a device substrate including a cavity formed therein, a diaphragm formed to cover the cavity on the device substrate, a back plate formed to be spaced apart from the diaphragm, and a shielding plate disposed to be spaced apart from the diaphragm and the back plate, including a plurality of through holes therein, and blocking noise introduced from outside.

The shielding plate may include a first plate, a second plate disposed in parallel to the first plate, and the through holes may be formed in both the first and second plates.

Through holes of the first plate and through holes of the second plates may be formed to be alternately disposed.

The through holes of the first plate and the through holes of the second plates may be spaced apart from each other when they are assumed to be positioned on the same plane.

The through holes of the first plate and the through holes of the second plates may partially overlap each other when they are assumed to be positioned on the same plane.

The first plate and the second plate may be separated by a predetermined interval corresponding to a width of each through hole.

The device substrate may include a metallic layer formed on an external surface thereof, and the metallic layer may be electrically connected to the shielding plate.

According to some embodiments of the present disclosure, a microphone package may include a package substrate, at least one acoustic device mounted on the package substrate, and at least one electronic device mounted on the package substrate, wherein the acoustic device may include a shielding plate including a plurality of through holes therein, disposed in a direction in which sound is input.

The acoustic device may include a device substrate including a cavity formed therein, a diaphragm formed to cover the cavity on the device substrate, a back plate formed to be spaced apart from the diaphragm, and the shielding plate is spaced apart from the diaphragm and the back plate.

The shielding plate may include a first plate, a second plate disposed in parallel to the first plate, and the through holes may be formed in both the first and second plates, and through holes of the first plate and through holes of the second plates may be formed to be alternately disposed.

According to some embodiments of the present disclosure, a microphone package may include a device substrate including an electronic device mounted therein and a cavity formed therein, a diaphragm formed to cover the cavity on the device substrate, a back plate formed to be spaced apart from the diaphragm, and a shielding plate spaced apart from the diaphragm and the back plate, including a plurality of through holes therein, and shielding noise introduced from outside.

The shielding plate may include a first plate, a second plate disposed in parallel to the first plate, and the through holes may be formed in both the first and second plates, and the through holes of the first plate and through holes of the second plates may be formed to be alternately disposed.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view of a microphone package according to an embodiment of the present disclosure;

FIG. 2 is a schematic cross-sectional view of an acoustic device illustrated in FIG. 1;

FIG. 3 is an enlarged cross-sectional view of a shielding plate of FIG. 2;

FIG. 4 is a plan view of a shielding plate when viewed in direction A of FIG. 2;

FIG. 5 is a schematic cross-sectional view of an acoustic device of a microphone package according to another embodiment of the present disclosure;

FIG. 6 is an enlarged cross-sectional view of a shielding plate illustrated in FIG. 5;

FIG. 7 is a plan view of the shielding plate viewed in direction A of FIG. 5; and

FIG. 8 is a cross-sectional view of a microphone package according to another embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

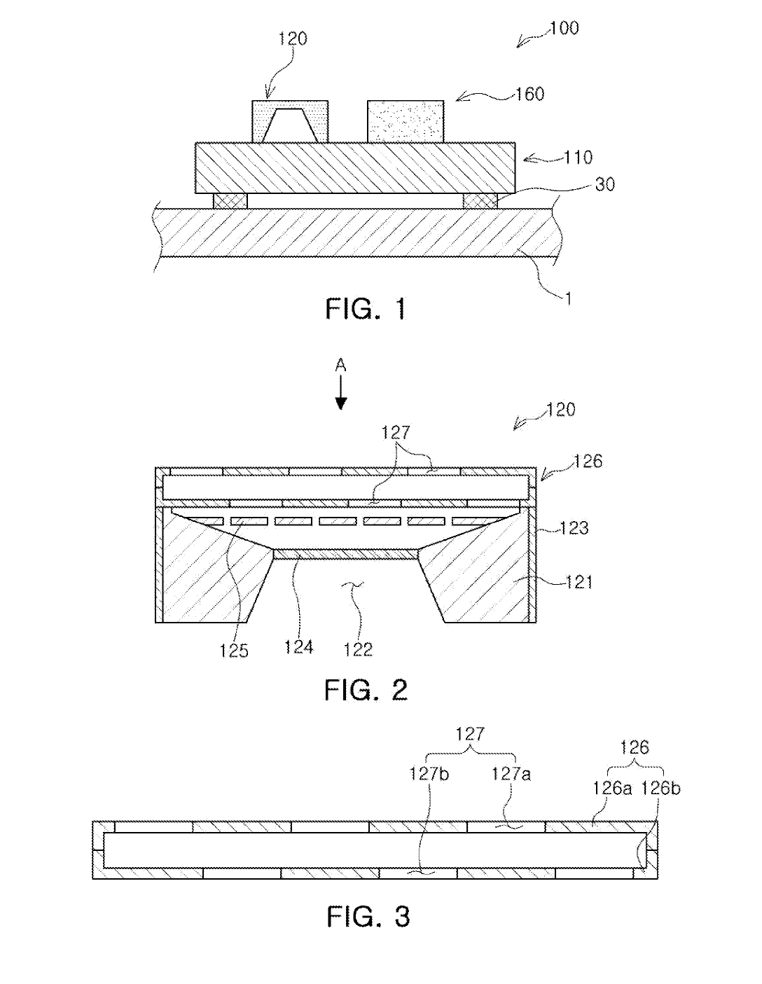

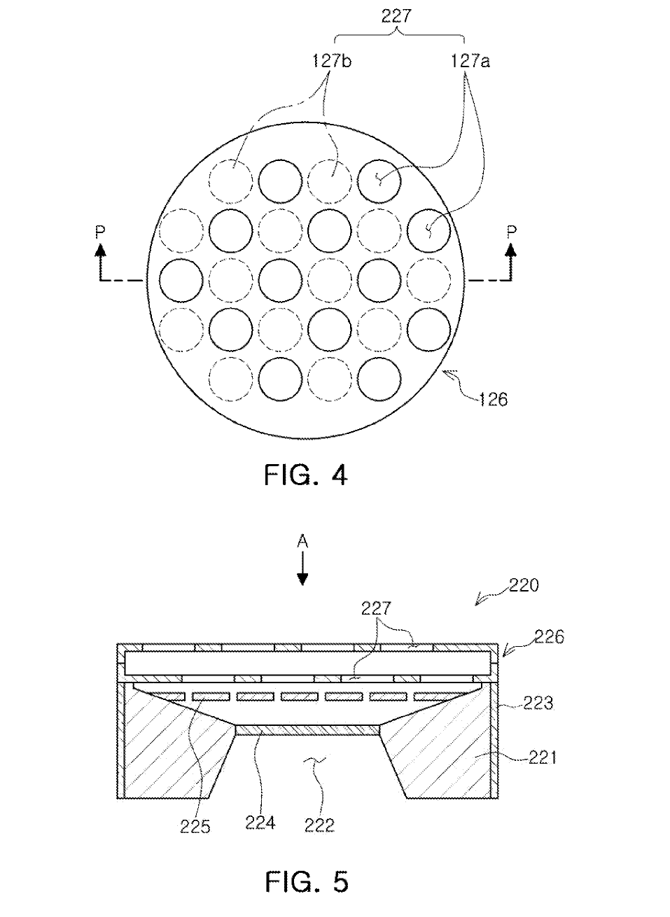

FIG. 1 is a schematic cross-sectional view of a microphone package 100 according to an embodiment of the present disclosure. FIG. 2 is a schematic cross-sectional view of an acoustic device 120 illustrated in FIG. 1. FIG. 3 is an enlarged cross-sectional view of a shielding plate 126 of FIG. 2. FIG. 4 is a plan view of the shielding plate 126 when viewed in direction A of FIG. 2.

Referring to FIGS. 1 to 4, the microphone package 100 according to the exemplary embodiment of the present disclosure may include a package device substrate 121, an acoustic device 120, and an electronic device 160. In addition, the microphone package 100 may further include other devices required for an operation of the acoustic device 120.

The microphone package 100 configured as described above may be mounted on a portable electronic device, may detect sound including voice, and may convert the detected sound into electrical signals.

Hereinafter, main components of the microphone package 100 will be described.

As a package substrate 110, various types of substrate (e.g., a ceramic substrate, a printed circuit board, a flexible substrate, and the like), well known in the art, may be used. In addition, mounting electrodes for mounting the acoustic device 120 or the electronic device 160, or wire patterns for forming electrical connection between the mounting electrodes may be formed on at least one surface of the package substrate 110.

The package substrate 110 according to the exemplary embodiment of the present disclosure may be a multilayered substrate including a plurality of layers and may include circuit patterns formed between the layers for electrical connections therebetween. However, embodiments of the present invention are not limited thereto. For example, the package substrate 110 may be formed as a single-layer substrate.

The package substrate 110 according to the exemplary embodiment of the present disclosure may include an external connection pad (not shown) formed on a lower surface thereof. The external connection pad may be used for forming an electrical connection with a main substrate 1, and external terminals 30 may be adhered to the external connection pad.

In addition, one or more electronic devices may be installed on or in the package substrate 110. Here, the electronic devices may include a passive device and an active device.

The package substrate 110 may be mounted on the main substrate 1 and may be electrically connected to the main substrate 1 through the plural external terminals 30. Here, the external terminal 30 may be a solder ball, a solder bump, or the like, but is not limited thereto.

In addition, a lower surface of the package substrate 110 may be adhered to and may surface-contact the main substrate 1, and then, the package substrate 110 may be electrically connected to the main substrate 1 via bonding wire. Likewise, various modifications may be possible.

The electronic device 160 may be a semiconductor device and may be an application-specific integrated circuit (ASIC). However, the configuration of the present disclosure is not limited thereto. For example, the electronic device 160 may include other typical electronic devices.

The electronic device 160 may be electrically connected to the acoustic device 120 via bonding wire or wire patterns of the device substrate 121, or the like.

The acoustic device 120 may be a silicon capacitor microphone device and may be manufactured as a micro electro mechanical system (MEMS).

The acoustic device 120 may convert sound into an electrical signals using electrostatic capacitance that varies according to movement of a vibration plate that vibrates in response to sound. To this end, the acoustic device 120 may include the device substrate 121, a back plate 125, a diaphragm 124, and a shielding plate 126.

The acoustic device 120 may be mounted on a portable terminal, a small sized electronic device, etc. In addition, the acoustic device 120 may be installed in an apparatus that detects sound or converts sound into an electrical signal.

Hereinafter, components of the acoustic device 120 will be described.

The device substrate 121 may be formed of single crystal silicon or silicon on insulator (SOI). In addition, the device substrate 121 may be obtained by stacking one or more silicon layers.

The device substrate 121 may constitute a body of the acoustic device 120. Alternatively, the device substrate 121 may be a portion of a portable terminal or small sized electronic device on which the acoustic device 120 is mounted. For example, the device substrate 121 may be a portion of a semiconductor package mounted on a portable terminal.

A cavity 122 may be formed in the device substrate 121. The cavity 122 may be formed via mechanical processing or chemical processing. For example, the cavity 122 may be formed via a dry or wet etching process. The cavity 122 formed likewise may be used as an inlet or back cavity into which sound waves are input.

A cross-sectional shape of the cavity 122 may be formed to become narrow toward one surface (an upper surface in terms of FIG. 2) of the device substrate 121 from the other surface (a lower surface in terms of FIG. 2). However, the cross-sectional shape of the cavity 122 is not limited to the aforementioned shape. Various modifications may be possible. For example, the cavity 122 may be formed so that the sectional shapes thereof are entirely constant.

In addition, a shield layer 123 may be formed on an external surface of the device substrate 121 according to the exemplary embodiment of the present disclosure. The shield layer 123 may be electrically connected to the shielding plate 126 that will be described hereinafter, to perform a function of shielding electromagnetic waves introduced from outside.

As necessary, the shield layer 123 may be omitted according to the material, internal structure, or the like of the device substrate 121.

The diaphragm 124 may be disposed on one surface (an upper surface in terms of FIG. 2) of the device substrate 121 and may be disposed to completely cover the cavity 122.

The diaphragm 124 disposed likewise may vibrate in a vertical direction (based on FIG. 2) according to an amplitude of sound waves input through the cavity 122. For example, the diaphragm 124 may be a vibration plate that vibrates according to acoustic pressure and may be a first electrode of a capacitor that measures electrostatic capacitance.

A plan view (or a horizontal cross-sectional view) of the diaphragm 124 according to the exemplary embodiment of the present disclosure may be a circular shape. For example, the plan view of the diaphragm 124 may be formed to have a circular shape having a different size from the cavity 122 and the same center as the cavity 122. However, the shape of the diaphragm 124 may not be limited to having a circular shape and may be polygonal.

The diaphragm 124 may be formed of a conductive material. For example, the diaphragm 124 may be formed of a polysilicon thin film having high electric conductivity. However, the diaphragm 124 does not have to be formed of a conductive material. For example, a conductive material may be coated on or a conductive film may be attached to one surface of the diaphragm 124.

The diaphragm 124 may be electrically connected to the electronic device 160 (see FIG. 1). According to the exemplary embodiment of the present disclosure, the case in which the diaphragm 124 and the electronic device 160 are electrically connected via wire patterns of the package substrate 110 is exemplified. Thus, the diaphragm 124 may be electrically connected to the package substrate 110 through the device substrate 121.

However, the configuration of the present disclosure is not limited thereto. Various applications may be possible. For example, the diaphragm 124 and the electronic device 160 may be electrically connected via conductive wires.

The back plate 125 may be formed on one surface (an upper layer in terms of FIG. 2) of the device substrate 121. In more detail, the back plate 125 may be disposed on the device substrate 121 to be approximately parallel to the diaphragm 124, above the diaphragm 124. However, embodiments of the present invention are not limited thereto. For example, the back plate 125 may be disposed below the diaphragm 124.

The back plate 125 may be disposed to form a predetermined space with the diaphragm 124. For example, the back plate 125 may be disposed to be spaced apart from the diaphragm 124 by a predetermined distance. Here, the predetermined distance may be greater than an amplitude of the diaphragm 124.

The back plate 125 may be a second electrode of a capacitor that measures electrostatic capacitance. Accordingly, a predetermined amount of electrostatic capacitance may be formed between the back plate 125 and the diaphragm 124.

To this end, the back plate 125 may be formed using a conductive material. However, the configuration of the present disclosure is not limited thereto. Various modifications may be possible. For example, the back plate 125 may be formed of an insulating material, and a metallic layer may be formed on one surface of the back plate facing the diaphragm 124 so as to be used as a second electrode.

A plurality of through holes may be formed in the back plate 125. When the diaphragm 124 vibrates according to acoustic pressure, the through holes may be used as a path for air movement.

The shielding plate 126 is disposed to be spaced apart from the diaphragm 124 and the back plate 125 and is coupled to the device substrate 121 so as to shied electromagnetic waves, electrostatic fields, noise, or the like introduced from outside.

The shielding plate 126 according to the exemplary embodiment of the present disclosure may include a first plate 126a and a second plate 126b.

The first plate 126a and the second plate 126b may be formed to have approximately similar shapes and may be spaced apart from each other in a direction parallel to each other.

The first plate 126a and the second plate 126b may be formed using a conductive material and may be electrically connected to each other. In addition, the first plate 126a and the second plate 126b may be electrically connected to a ground of the main substrate 1 through the package substrate 110.

A plurality of through holes 127 may be formed in the first plate 126a and the second plate 126b. The through holes 127 may be formed with the same size but are not limited thereto. As necessary, the through holes 127 may be formed with different sizes. In addition, the through holes 127 may be spaced apart from each other by a predetermined interval.

Through holes 127a of the first plate 126a and through holes 127b of the second plate 126b may be formed in different locations. In more detail, while the first plate 126a and the second plate 126b correspond to each other, the through holes 127a of the first plate 126a may be interposed with the through holes 127b of the second plate 126b. In this case, the through holes 127b of the second plate 126b may be interposed with the through holes 127a of the first plate 126a.

Thus, viewed in direction A of FIG. 2, the through holes 127a of the first plate 126a are visible to the naked eye, but the through holes 127b of the second plate 126b are hidden by the first plate 126a, and thus, it may be difficult to identify the through holes 127b of the second plate 126b with the naked eye, as illustrated in FIG. 4.

For example, when the through holes 127a of the first plate 126a and the through holes 127b of the second plate 126b are assumed to be positioned on the same plane, the through holes 127a of the first plate 126a and the through holes 127b of the second plate 126b may be spaced apart from each other.

The shielding plate 126 configured likewise may provide a Faraday cage or Faraday shield effect. For example, the shielding plate 126 shields external electrostatic fields or electromagnetic waves.

Thus, the shielding plate 126 may be disposed frontmost in a direction in which sound is input. For example, in FIG. 2, when sound is input in direction A, the shielding plate 126 may be disposed as illustrated in FIG. 2. However, when sound is input in a direction opposite to direction A, the shielding plate 126 may be disposed on an opposite side to FIG. 2.

In addition, the acoustic device 120 according to the exemplary embodiment of the present disclosure may be configured in such a way that the through hole 127 of the shielding plate 126 may be formed with a relatively large size so as to smoothen sound when acoustic pressure is applied to the diaphragm 124. Here, the size of the through hole 127 may be larger than a size of a through hole of the back plate 125 and may be formed with a size such that mainly input sound such as voice may be smoothly introduced.

Furthermore, the first plate 126a and the second plate 126b may be spaced apart from each other by a distance corresponding to the size (diameter or width) of the through hole 127, which is configuration for smoothly introduce sound toward the diaphragm 124. As necessary, modifications may be possible.

According to the exemplary embodiment of the present disclosure, the case in which the shielding plate 126 includes two plates 126a and 126b is exemplified. However, the configuration of the present disclosure is not limited thereto. For example, the shielding plate 126 may include three or four plates.

In addition, according to the exemplary embodiment of the present disclosure, the case in which the shielding plate 126 is formed of a conductive material, for example, a metallic material is exemplified. However, the shielding plate 126 may be formed using an insulating material and then forming a metallic layer on one surface of thereof.

An acoustic device and a microphone package including the same according to the present disclosure are not limited to the aforementioned embodiment. Various modifications are possible.

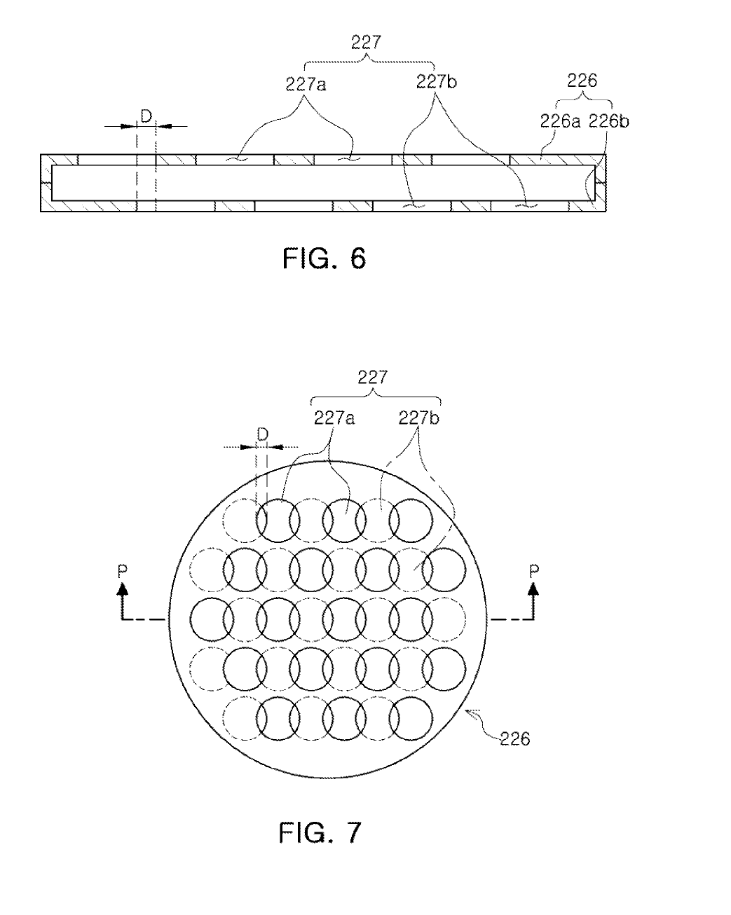

FIG. 5 is a schematic cross-sectional view of an acoustic device 220 of a microphone package according to another embodiment of the present disclosure. FIG. 6 is an enlarged cross-sectional view of a shielding plate 226 illustrated in FIG. 5. FIG. 7 is a plan view of the shielding plate 226 viewed in direction A of FIG. 5.

The acoustic device 220 according to the exemplary embodiment of the present disclosure is configured in a similar way to the aforementioned acoustic device 120 (see to FIG. 2) except for the configuration of the shielding plate 226. Thus, a detailed description of the same component will be omitted and the configuration of the shielding plate 226 will be described in more detail.

Referring to FIGS. 5 to 7, the acoustic device 220 according to the exemplary embodiment of the present disclosure may be configured in such a way that through holes 227a of a first plate 226a and through holes 227b of a second plate 226b may partially overlap each other in a vertical direction.

Thus, as viewed in direction A of FIG. 5, a portion of the through hole 227b of the second plate 226b may be visible to the naked eye through the through holes 227a of the first plate 226a, and a region below the second plate 226b may be visible through the through holes 227a and the through hole 227b.

For example, when the through holes 227a of the first plate 226a and the through holes 227b of the second plate 226b are viewed in direction A of FIG. 5 under the assumption that they are positioned on the same plane, the through holes 227a of the first plate 226a and the through holes 227b of the second plate 226b may partially overlap each other.

Here, as viewed in direction A, the size of the visible through hole may have a size corresponding to a wavelength of electromagnetic wave or noise. For example, the through hole according to the exemplary embodiment of the present disclosure may have a size within a range, which is difficult to pass general electromagnetic wave or noise.

According to the exemplary embodiment of the present disclosure, the acoustic device and the microphone package including the same configured as described above include a shielding plate for shielding electromagnetic waves by the acoustic device itself. Thus, unlike a related art, although a shield cover is not used, electromagnetic waves introduced to the acoustic device from outside may be easily shielded.

In addition, the shielding plate may be manufactured via a MEMS process like a back plate or a diaphragm and thus may be advantageous in that the shielding plate is easily manufactured.

Furthermore, at least two shielding plates of the acoustic device according to the exemplary embodiment of the present disclosure may be disposed such that through holes of one plate and through holes of other plates are alternately arranged.

Accordingly, high frequency noise with strong straightness may be easily shielded by the shielding plate and low frequency sound with strong diffractive characteristics such as voice may be easily introduced to the diaphragm through the through holes of the shielding plate.

Thus, even in a case in which the shielding plate is formed directly on the acoustic device, reductions in sensitivity due thereto may be significantly reduced.

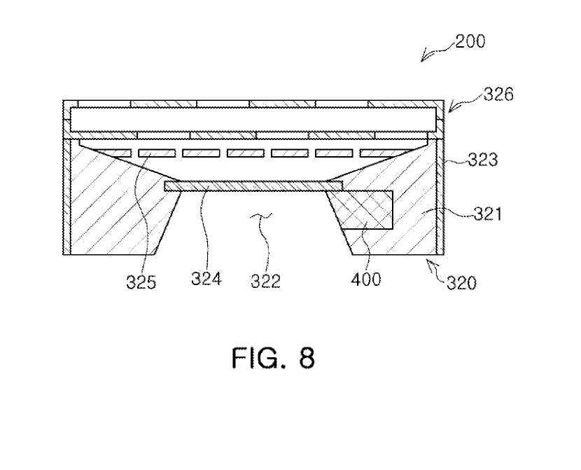

FIG. 8 is a cross-sectional view of a microphone package 200 according to another embodiment of the present disclosure.

Referring to FIG. 8, the microphone package 200 according to the exemplary embodiment of the present disclosure is configured in such a way that an acoustic device 320 and an electronic device 400 (e.g., an ASIC device) may be integrally formed. For example, an electronic device 400 is also formed on one side of a device substrate 321 of the acoustic device 320. In addition, a diaphragm 324 and a back plate 325 that constitute an electrode of the acoustic device 320 are electrically connected to the electronic device 400.

Thus, the microphone package 200 may be formed via a process of manufacturing one device component.

This configuration may be obtained by including the shielding plate according to the exemplary embodiment of the present disclosure in the acoustic device itself. In the related art, it may be difficult to shield electromagnetic waves by only an acoustic device, and thus, a shield cover needs to be included, and thus, a substrate (for example, a package substrate) to which the cover is coupled is needed.

However, according to the exemplary embodiment of the present disclosure, when the acoustic device itself shields electromagnetic waves, a shield cover may be omitted, and thus, a package substrate may also be omitted. Thus, like in the exemplary embodiment of the present disclosure, an acoustic device and an electronic device may constitute a single device component without a substrate.

Likewise, when a microphone package is formed as a single device component, the microphone package may be very easily manufactured, and the overall size thereof may be significantly reduced.

An acoustic device and a microphone package including the same according to exemplary embodiments of the present disclosure include a shielding plate for shielding electromagnetic waves by an acoustic device itself. Thus, unlike in the related art, although a shield cover is not used, electromagnetic waves introduced to the acoustic device from outside may be easily shielded.

In addition, the shielding plate may be manufactured via a MEMS process like a back plate or a diaphragm and thus may be advantageous in that the shielding plate is easily manufactured.

Furthermore, at least two shielding plates of the acoustic device according to an exemplary embodiment of the present disclosure may be disposed such that through holes of one plate and through holes of other plates are alternately arranged.

Accordingly, high frequency noise with strong linearity may be easily shielded by the shielding plate and low frequency sound with strong diffractive characteristics such as voice may be easily introduced to the diaphragm through the through holes of the shielding plate.

Thus, even when the shielding plate is formed directly on the acoustic device, reduction in sensitivity due to this may be significantly reduced.

While exemplary embodiments have been shown and described above, it will be apparent to those skilled in the art that modifications and variations could be made without departing from the spirit and scope of the present disclosure as defined by the appended claims.

What is claimed is:

1. An acoustic device comprising:
a device substrate including a cavity formed therein;
a diaphragm formed to cover the cavity on the device substrate;
a back plate formed to be spaced apart from the diaphragm; and
a shielding plate disposed to be spaced apart from the diaphragm and the back plate, including a plurality of through holes therein, and blocking noise introduced from outside.

2. The acoustic device of claim 1, wherein the shielding plate comprises a first plate, and a second plate disposed in parallel to the first plate; and
the through holes are formed in both the first and second plates.

3. The acoustic device of claim 2, wherein through holes of the first plate and through holes of the second plates are formed to be alternately disposed.

4. The acoustic device of claim 3, wherein the through holes of the first plate and the through holes of the second plates are spaced apart from each other when they are assumed to be positioned on the same plane.

5. The acoustic device of claim 3, wherein the through holes of the first plate and the through holes of the second plates partially overlap each other when they are assumed to be positioned on the same plane.

6. The acoustic device of claim 3, wherein the first plate and the second plate are separated by a predetermined interval corresponding to a width of each through hole.

7. The acoustic device of claim 3, wherein:
the device substrate includes a metallic layer formed on an external surface thereof; and
the metallic layer is electrically connected to the shielding plate.

8. A microphone package comprising:
a package substrate;
at least one acoustic device mounted on the package substrate; and
at least one electronic device mounted on the package substrate,
wherein the acoustic device includes a shielding plate including a plurality of through holes, disposed in a direction in which sound is input.

9. The microphone package of claim 8, wherein:
the acoustic device comprises a device substrate including a cavity formed therein, a diaphragm formed to cover the cavity on the device substrate, a back plate formed to be spaced apart from the diaphragm; and
the shielding plate is spaced apart from the diaphragm and the back plate.

10. The microphone package of claim 9, wherein:
the shielding plate includes a first plate, and a second plate disposed in parallel to the first plate; and
the through holes are formed in both the first and second plates, and through holes of the first plate and through holes of the second plates are formed to be alternately disposed.

11. A microphone package comprising:
a device substrate including an electronic device mounted therein and a cavity formed therein;
a diaphragm formed to cover the cavity on the device substrate;
a back plate formed to be spaced apart from the diaphragm; and
a shielding plate spaced apart from the diaphragm and the back plate, including a plurality of through holes, and shielding noise introduced from outside.

12. The microphone package of claim 11, wherein:
the shielding plate includes a first plate, and a second plate disposed in parallel to the first plate; and
the through holes are formed in both the first and second plates, and the through holes of the first plate and through holes of the second plates are formed to be alternately disposed.
